(19) United States
(12) Patent Application Publication
(10) Pub. No.: US 2026/0237670 A1
(43) Pub. Date: Aug. 13, 2026

(54) NEGATIVE ELECTRODE BODY AND MANUFACTURING METHOD OF THE SAME

(71) Applicant: TOYOTA JIDOSHA KABUSHIKI KAISHA, Toyota-shi (JP)

(72) Inventors: Tomoyuki UEZONO, Okazaki-shi (JP); Tomohisa KIDA, Miyoshi-shi (JP); Nariaki MIKI, Okazaki-shi (JP); Minehiro FUNATO, Toyota-shi (JP)

(73) Assignee: TOYOTA JIDOSHA KABUSHIKI KAISHA, Toyota-shi (JP)

(21) Appl. No.: 19/421,404

(22) Filed: Dec. 16, 2025

(30) Foreign Application Priority Data
Feb. 10, 2025 (JP) 2025-020079

(51) Int. Cl. H01M 4/62; H01M 4/02; H01M 4/04; H01M 4/133; H01M 4/587

(52) U.S. Cl. CPC H01M 4/622; H01M 4/0404; H01M 4/133; H01M 4/587; H01M 2004/027

(57) ABSTRACT

The negative electrode body includes a current collector, and a negative electrode material layer provided on the current collector. The negative electrode material layer includes first active material particles containing a carbon material, second active material particles containing a silicon-based material, the second active material particles being dispersed among the first active material particles, and a superabsorbent polymer adhering to a surface of the second active material particles such that a void is provided between the superabsorbent polymer and the first active material particles.

### CROSS-REFERENCE TO RELATED APPLICATION

This application claims priority to Japanese Patent Application No. 2025-020079 filed on Feb. 10, 2025. The disclosure of the above-identified application, including the specification, drawings, and claims, is incorporated by reference herein in its entirety.

### BACKGROUND

### 1. Technical Field

The technology disclosed in the present specification relates to a negative electrode body of a battery (typically, a non-aqueous secondary battery) and a manufacturing method of the same.

### 2. Description of Related Art

Japanese Unexamined Patent Application Publication (Translation of PCT Application) No. 2024-526507 (JP 2024-526507 A) discloses a negative electrode body. The negative electrode body includes a negative electrode material layer provided on a current collector. The negative electrode material layer includes porous carbon and a negative electrode active material filled into a pore structure of the porous carbon. Silicon nanoparticles are employed as the negative electrode active material.

### SUMMARY

As a negative electrode active material of the battery, a silicon-based material (including silicon single body) has a higher capacity than a carbon material. Therefore, for example, in the field of lithium ion batteries, a silicon-based material as a negative electrode active material has attracted attention. On the other hand, the silicon-based material has a relatively large volume change during charge and discharge. Therefore, in a case where the negative electrode material layer includes the silicon-based material, expansion of the electrode that occurs during charging is a problem. In the present specification, a novel technology for suppressing the expansion of the electrode in the negative electrode material layer including the silicon-based material is provided.

The technology disclosed in the present specification is embodied in a manufacturing method of a negative electrode body. The manufacturing method includes producing composite particles by causing a superabsorbent polymer to adhere to a surface of second active material particles containing a silicon-based material, producing a negative electrode material paste by mixing the composite particles, first active material particles containing a carbon material, and water, applying the negative electrode material paste onto a surface of a current collector, and drying the negative electrode material paste applied onto the surface of the current collector to shrink the superabsorbent polymer adhering to the surface of the second active material particles, and providing a void between the superabsorbent polymer and the first active material particles.

According to the above configuration, in the negative electrode material paste applied onto the surface of the current collector, the second active material particles containing the silicon-based material are dispersed among the first active material particles containing the carbon material. In addition, the superabsorbent polymer in a swollen state adheres to the surface of the second active material particles, and the superabsorbent polymer is interposed between the first active material particles and the second active material particles. In a case where the negative electrode material paste having such a structure is dried, the superabsorbent polymer shrinks, and thus a void is provided between the superabsorbent polymer adhering to the second active material particles and the first active material particles. That is, a void is provided around the second active material particles. As a result, in the manufactured negative electrode body, even when the second active material particles expand during charging, the expansion of the electrode caused by the expansion of the second active material particles can be suppressed.

In the manufacturing method, in the producing the composite particles, the composite particles may be produced by mixing the second active material particles, the superabsorbent polymer, and water.

According to such a configuration, the superabsorbent polymer swells, and thus friction between the superabsorbent polymer and the second active material particles increases. As a result, the generation of the composite particles is promoted.

The technology disclosed in the present specification is also embodied in a negative electrode body. The negative electrode body is not particularly limited, but can be manufactured by the manufacturing method. The negative electrode body includes:
a current collector; and
a negative electrode material layer provided on the current collector.

The negative electrode material layer includes
first active material particles containing a carbon material,
second active material particles containing a silicon-based material, the second active material particles being dispersed among the first active material particles, and
a superabsorbent polymer adhering to a surface of the second active material particles such that a void is provided between the superabsorbent polymer and the first active material particles.

According to such a configuration, since a void is present around the second active material particles, even when the second active material particles expand during charging, the expansion of the electrode caused by the expansion of the second active material particles can be suppressed.

In either or both of the negative electrode body and the manufacturing method, the superabsorbent polymer may include at least one selected from the group consisting of polyacrylic acid, polyvinyl alcohol, polyethylene glycol, and polyacrylonitrile.

In addition to or instead of the above,
the silicon-based material includes at least one selected from the group consisting of silicon, silicon carbide, silicon monoxide, and a silicon alloy.

As described above, in the present technology, the superabsorbent polymer is, beforehand, caused to adhere to the surface of the second active material particles. Therefore, the superabsorbent polymer is localized around the second active material particles. In this case,
in the negative electrode material layer, a content of the superabsorbent polymer in a unit region including the second active material particles can be at least 10 times a content of the superabsorbent polymer in a unit region not including the second active material particles.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view of a negative electrode body;

FIG. 2 is a diagram for describing a manufacturing method of the negative electrode body;

FIG. 3 is a diagram for describing the manufacturing method of the negative electrode body;

FIG. 4 is a diagram for describing the manufacturing method of the negative electrode body;

FIG. 5 is a diagram for describing the manufacturing method of the negative electrode body; and

FIG. 6 is a flowchart showing a series of procedures of the manufacturing method of the negative electrode body.

### DETAILED DESCRIPTION OF EMBODIMENTS

### Configuration of Negative Electrode Body

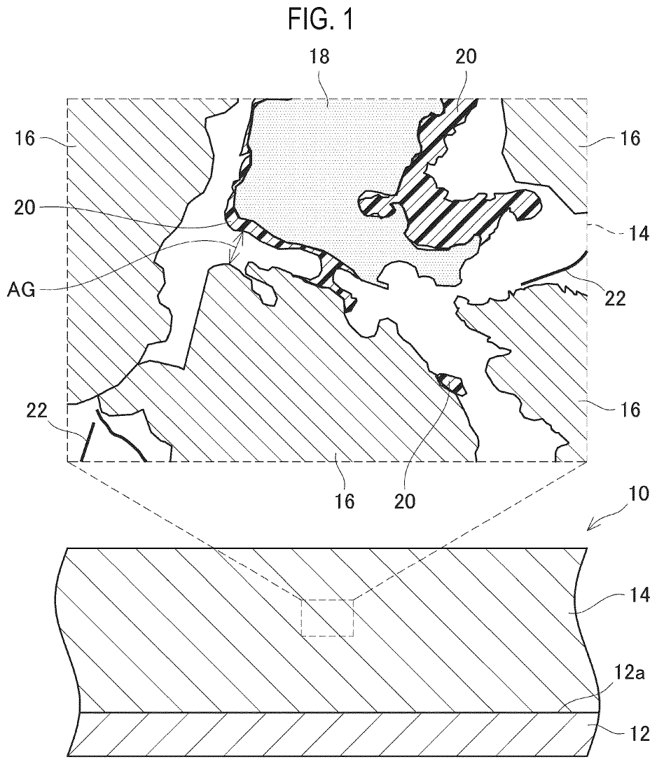

A negative electrode body 10 according to an embodiment will be described with reference to the drawings. The negative electrode body 10 can be used as a negative electrode of a secondary battery such as a lithium ion battery. In particular, the negative electrode body 10 is used in a non-aqueous secondary battery using a non-aqueous electrolyte. As shown in FIG. 1, the negative electrode body 10 includes a current collector 12 and a negative electrode material layer 14. The negative electrode material layer 14 is disposed on a surface 12a of the current collector 12. The negative electrode material layer 14 may be disposed not only on the surface 12a of the current collector 12 but also on a back surface thereof.

The current collector 12 may be a sheet material having conductivity, and may be, for example, a copper foil or a metal foil. In this case, the current collector 12 is not particularly limited, but at least the surface 12a thereof may contain copper. A thickness of the current collector 12 may be a thickness of about 5 μm or more and about 50 μm or less. The current collector 12 may contain a material having conductivity, and may contain a metal other than copper.

FIG. 1 shows a cross-sectional view of the negative electrode body 10 (lower part of FIG. 1) and a cross-sectional view of a part of the negative electrode material layer 14 (upper part of FIG. 1). As shown in FIG. 1, the negative electrode material layer 14 includes first active material particles 16, second active material particles 18, a superabsorbent polymer 20, and a conductive additive 22.

The first active material particles 16 are a main component of the active material of the negative electrode material layer 14. The first active material particles 16 are composed of a carbon material. Examples of the carbon material include graphite, hard carbon, and soft carbon. Typically, the first active material particles 16 are graphite. A particle diameter of the first active material particles 16 may be about 5 μm or more and about 50 μm or less. Here, the “particle diameter” described in the present specification is an average particle diameter, and means a particle diameter (D50) at a cumulative value of 50% in a volume-based particle size distribution measured by a laser diffraction and scattering method.

The second active material particles 18 are used as an active material of the negative electrode material layer 14 together with the first active material particles 16. A content of the second active material particles 18 in the negative electrode material layer 14 is sufficiently lower than a content of the first active material particles 16 in the negative electrode material layer 14, and the second active material particles 18 are dispersed among the first active material particles 16. That is, in the negative electrode material layer 14, the second active material particles 18 are disposed to be surrounded by the first active material particles 16. The second active material particles 18 contain a silicon-based material including silicon. Examples of the silicon-based material include silicon (Si), a silicon oxide such as silicon carbide (SiC) and silicon monoxide (SiO), and a silicon alloy (an alloy containing silicon and another metal such as aluminum (Al), iron (Fe), and manganese (Mn)). Typically, the second active material particles 18 are silicon carbide. The silicon-based material may contain one kind of material or may contain a plurality of kinds of materials. A particle diameter of the second active material particles 18 may be about 5 μm or more and about 50 μm or less.

The superabsorbent polymer 20 adheres to a surface of the second active material particles 18 and provides a void AG between the superabsorbent polymer 20 and the first active material particles 16. Examples of the superabsorbent polymer 20 include polyacrylic acid (PAA), polyvinyl alcohol (PVA), polyethylene glycol (PEG), and polyacrylonitrile (PAN). Typically, the superabsorbent polymer 20 is polyacrylic acid. The superabsorbent polymer 20 may contain one kind of material or may contain a plurality of kinds of materials. Although it is an example, the superabsorbent polymer 20 also functions as a binder of the negative electrode material layer 14. However, in the modification, the negative electrode material layer 14 may include a binder other than the superabsorbent polymer 20.

The conductive additive 22 is dispersed among the active material particles 16 and 18 in the negative electrode material layer 14. Examples of the conductive additive 22 include a carbon material such as carbon nanotubes, carbon black (for example, acetylene black, furnace black, and Ketjen black), coke, and graphite. Typically, for example, single-walled carbon nanotubes are employed as the conductive additive 22. The conductive additive 22 may contain one kind of material or may contain a plurality of kinds of materials. However, in the modification, the negative electrode material layer 14 need not include the conductive additive 22.

### Manufacturing Method of Negative Electrode Body

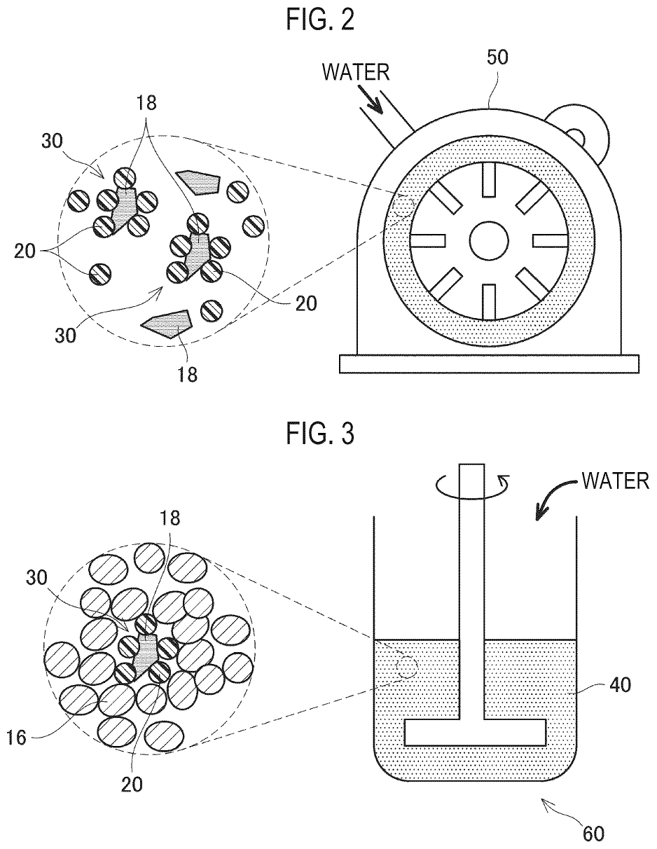

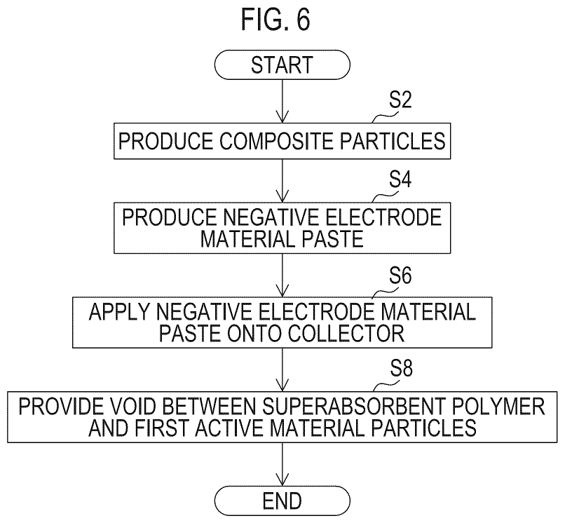

An example of a manufacturing method of the negative electrode body 10 will be described with reference to FIGS. 2 to 6. The negative electrode body 10 can be manufactured according to the flow shown in FIG. 6.

In S2, a step of producing composite particles 30 by mixing the second active material particles 18 and the superabsorbent polymer 20 is performed. Specifically, as shown in FIG. 2, the composite particles 30 are produced by causing the superabsorbent polymer 20 to adhere to the surface of the second active material particles 18. The superabsorbent polymer 20 used here may be in a granular form. In this case, a particle diameter of the superabsorbent polymer 20 in a case of being swollen by absorbing water may be about 1 μm or more and about 2 μm or less. Although it is an example, a hybridization system 50 can be employed to produce the composite particles 30. However, the production of the composite particles 30 is not limited to the hybridization system 50, and other types of devices that can be used for the compounding of particles may be used. Typically, a wet process of mixing water together with the second active material particles 18 and the superabsorbent polymer 20 may be employed. In a case where the composite particles 30 are produced by the wet process, the superabsorbent polymer 20 swells, and thus friction between the superabsorbent polymer 20 and the second active material particles 18 is increased, and as a result, the generation of the composite particles 30 is promoted. In a case where the wet process is employed, the produced composite particles 30 may be dried, and then S4 may be performed. However, a dry process in which water is not mixed may be employed instead of the wet process to produce the composite particles 30.

In S4, a step of producing a negative electrode material paste 40 by mixing the composite particles 30 produced in S2, the first active material particles 16, and water is performed. Specifically, as shown in FIG. 3, first, the composite particles 30, the first active material particles 16, and water are mixed with each other using, for example, a mixer 60. The obtained mixture is further mixed with water, and then a dispersion liquid containing the conductive additive 22 is further mixed therewith to produce the negative electrode material paste 40. In this case, as shown in FIG. 3, the composite particles 30 are dispersed among the first active material particles 16 in the negative electrode material paste 40. That is, the composite particles 30 are mixed with water, and thus the superabsorbent polymer 20 in a swollen state is adhering to the surface of the second active material particles 18. In addition, the swollen superabsorbent polymer 20 is interposed between the first active material particles 16 and the second active material particles 18.

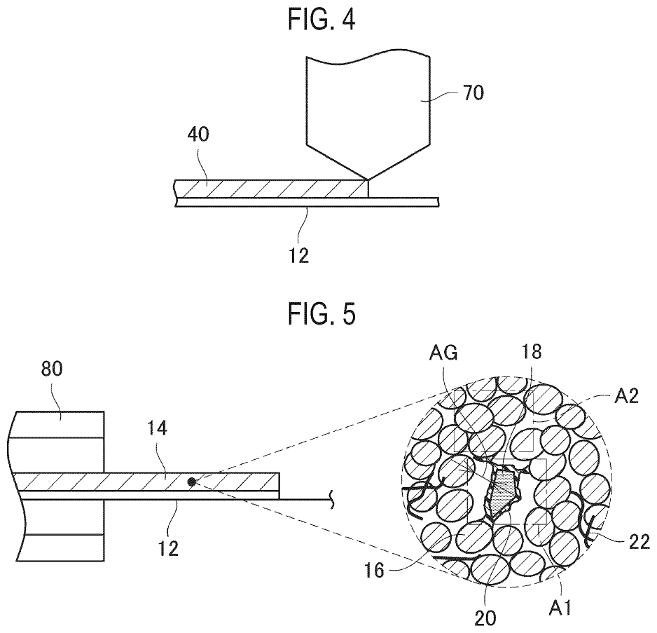

In S6, as shown in FIG. 4, for example, a step of applying the negative electrode material paste 40 produced in S4 onto the current collector 12 using an applicator is performed.

In S8, a step of providing the void AG between the superabsorbent polymer 20 and the first active material particles 16 is performed. Specifically, the negative electrode material paste 40 applied to the current collector 12 in S6 is dried, for example, in a drying furnace 80. As a result, the superabsorbent polymer 20 in a swollen state adhering to the surface of the second active material particles 18 shrinks (that is, is dehydrated). As a result, the void AG is provided between the superabsorbent polymer 20 and the first active material particles 16.

The negative electrode body 10 is manufactured by the above steps. As described above, when the negative electrode material layer 14 is still the negative electrode material paste 40, the superabsorbent polymer 20 in a swollen state is adhering to the surface of the second active material particles 18. In addition, the superabsorbent polymer 20 is interposed between the first active material particles 16 and the second active material particles 18. When the negative electrode material paste 40 having such a structure is dried, the superabsorbent polymer 20 shrinks, and thus the void AG is provided between the superabsorbent polymer 20 adhering to the second active material particles 18 and the first active material particles 16. That is, a void is provided around the second active material particles 18. As a result, in the manufactured negative electrode body 10, even when the second active material particles 18 expand during charging, the expansion of the electrode (that is, the negative electrode body 10) caused by the expansion of the second active material particles 18 can be suppressed.

In the manufacturing method of the negative electrode body 10, the superabsorbent polymer 20 is, beforehand, caused to adhere to the surface of the second active material particles 18. Therefore, the superabsorbent polymer 20 is localized around the second active material particles 18 of the negative electrode material layer 14. For example, as shown in FIG. 5, in the negative electrode material layer 14, a content of the superabsorbent polymer 20 in a first unit region (A1 in FIG. 5) may be at least 10 times a content of the superabsorbent polymer 20 in a second unit region (A2 in FIG. 5). The first unit region includes the second active material particles 18. The second unit region does not include the second active material particles 18. The localization of the superabsorbent polymer 20 around the second active material particles 18 can be observed by a cross-sectional image using a scanning electron microscope (SEM) or the like in the negative electrode material layer 14 as shown in FIG. 1.

Next, Embodiments according to the present technology will be described with reference to Table 1. However, the following description is not intended to limit the configuration according to the present technology. First, the negative electrode bodies 10 of Embodiments 1 to 4 and the negative electrode body of Comparative Example were produced.

### Negative Electrode Body of Embodiment 1

The negative electrode body 10 of Embodiment 1 was produced according to the manufacturing method. Graphite was used as the first active material particles 16. Silicon carbide was used as the second active material particles 18. Polyacrylic acid (PAA) particles were used as the binder. As the superabsorbent polymer 20, polyacrylic acid (PAA) particles were used, in which a particle diameter (hereinafter, referred to as a swollen particle diameter) of PAA in a case of being swollen by absorbing water was 1.0 μm. Single-walled carbon nanotubes (SWCNT) were used as the conductive additive 22, and a 0.4% by mass dispersion liquid of SWCNT was used as a conductive additive dispersion liquid. The first active material particles 16 and the second active material particles 18 were blended such that a mass ratio of the first active material particles 16 to the second active material particles 18 was 80/20.

In the step of producing the composite particles 30 (S2 in FIG. 6), the second active material particles 18 and the superabsorbent polymer 20 were mixed by a dry process using the hybridization system 50 (rotational speed: 15 m/s, compounding time: 15 minutes). As a result, the composite particles 30 were produced.

In the step of producing the negative electrode material paste 40 (S4 in FIG. 6), first, the first active material particles 16 and water were added to the produced composite particles 30, and the mixture was mixed using a mixer. The obtained mixture was further mixed with water, and then a solution of the conductive additive 22 containing a dispersant was further added thereto and mixed. As a result, the negative electrode material paste 40 was produced.

In the step of applying the negative electrode material paste 40 (S6 in FIG. 6), the negative electrode material paste 40 was applied onto the current collector 12 using an applicator. A copper foil (thickness: 8 μm) was used as the current collector 12.

In the step of forming the void AG (S8 in FIG. 6), the negative electrode material paste 40 applied onto the current collector 12 was dried using a drying furnace at 100° C. As a result, in the negative electrode material layer 14, the superabsorbent polymer 20 was dried and shrunk, and the void AG was provided between the superabsorbent polymer 20 and the first active material particles 16. In the negative electrode material layer 14, a mass ratio of the negative electrode active material/conductive additive 22/dispersant/PAA is 97.75/0.10/0.15/2.00. The mass of PAA here refers to the sum of the mass of the binder and the mass of the superabsorbent polymer 20. A single-side areal loading of the negative electrode material layer 14 on the current collector 12 was 7.3 mg/cm². Finally, the negative electrode material layer 14 was compressed using a roll press, and the density of the negative electrode material layer 14 was adjusted to be 1.0 g/cm³.

### Negative Electrode Body of Embodiments 2 to 4

In Embodiments 2 to 4, the negative electrode body 10 was produced by changing the step of producing the composite particles 30, respectively, as compared with Embodiment 1. In the step of producing the composite particles 30 of Embodiment 2, a wet process was used instead of the dry process of Embodiment 1. In the step of producing the composite particles 30 of Embodiment 3, as the superabsorbent polymer 20, PAA particles having a swollen particle diameter of 1.4 μm were used instead of the PAA particles having a swollen particle diameter of 1.0 μm of Embodiment 1. In the step of producing the composite particles 30 of Embodiment 4, the same wet process as that of Embodiment 2 was used, and PAA particles having a swollen particle diameter of 1.4 μm were used as the superabsorbent polymer 20, as in Embodiment 3. The negative electrode body 10 was produced by the same manufacturing method as that of Embodiment 1 for the other steps.

### Negative Electrode Body of Comparative Example

In the Comparative Example, the step of producing the composite particles 30 and the step of producing the negative electrode material paste 40 were changed as compared with Embodiment 1. In addition, the same PAA as that of Embodiment 1 was used as the binder. However, a PAA aqueous solution was used as the binder solution instead of the PAA particles of Embodiment 1. Specifically, first, the first active material particles 16, the second active material particles 18, the binder solution, and water were mixed using a mixer. Thereafter, the binder solution was further mixed with the obtained mixture to produce the negative electrode material paste. That is, in the Comparative Example, the negative electrode material paste was produced by omitting the step of producing the composite particles 30. Each of the other steps is the same as that of the manufacturing method of Embodiment 1.

### Positive Electrode Body

The same positive electrode body was used for Embodiments 1 to 4 and Comparative Example. Lithium nickel cobalt manganese oxide (NCM, manufactured by Sumitomo Metal Mining Co., Ltd.) was used as the positive electrode active material. Acetylene black (manufactured by Denka Company Limited., “Li-435”) was used as the conductive material. Polyvinylidene fluoride (PVdF) was used as the binder. As the binder solution, a 5% by mass PVdF-N-methyl-2-pyrrolidone (NMP)-based solution (manufactured by Kureha Battery Materials Japan (KBMJ) Co., Ltd., “#7305”) was used.

First, the positive electrode active material, the conductive material, and the binder solution were mixed using a mixer. The binder solution was further added to the obtained mixture to produce a positive electrode material paste. Next, the obtained positive electrode material paste was applied onto a current collector using an applicator. An aluminum foil (thickness: 12 μm) was used as the current collector. The positive electrode material paste applied onto the current collector was dried using a drying furnace at 120° C. As a result, a positive electrode body including a positive electrode material layer was produced. In the positive electrode material layer, a mass ratio of the positive electrode active material/conductive material/binder was 95/2.5/2.5. A single-side areal loading of the positive electrode material layer on the current collector was 19.5 mg/cm². Finally, the positive electrode material layer was compressed using a roll press, and the density of the positive electrode material layer was adjusted to be 3.1 g/cm³.

### Evaluation of Battery Cell

The negative electrode body 10 of Embodiment 1 and the positive electrode body were laminated with a separator interposed therebetween, and a non-aqueous electrolytic solution was introduced into the obtained laminate to produce a laminated battery cell. Battery cells were also produced in the same manner for the negative electrode bodies 10 of Embodiments 2 to 4 and the negative electrode body of Comparative Example.

### Evaluation of Battery Cell

For each of the produced battery cells, an initial direct-current internal resistance (DCIR) value, a capacity retention, and a cycle swelling ratio were evaluated. The evaluation results are shown in Table 1. The capacity retention here is a ratio of the full charge capacity after 100 cycles of charging and discharging at a rate of 0.5C to the initial full charge capacity, where the full charge capacity of the battery after 100 cycles of charging and discharging at a rate of 0.5C is measured. In addition, in the measurement of the cycle swelling ratio, a contact type displacement meter was installed on the battery cell, and a displacement amount of the thickness of the battery cell during the plurality of cycles (for example, several tens of cycles) of charging and discharging was measured. The cycle swelling ratio is a ratio of the displacement amount of the thickness of the battery cell during the plurality of cycles to the thickness of the initial battery cell.

The initial DCIR value, the capacity retention, and the cycle swelling ratio measured in each battery cell are shown in Table 1. In Table 1, the measurement results were described as “Good”, “Fair”, and “Poor” for the performance of the battery, respectively. In the initial DCIR value, in a case where the measurement result was 2Ω or less, it was determined to be “Fair”, and in a case where the measurement result exceeded 2Ω, it was determined to be “Poor”. In the capacity retention, in a case where the measurement result was 90% or more, it was determined to be “Fair”, and in a case where the measurement result was less than 90%, it was determined to be “Poor”. In the cycle swelling ratio, the lower the measurement result, the higher the performance as a battery, and it was determined to be “Good” in a case of less than 2.5%, “Fair” in a case of 2.5% or more and less than 3%, and “Poor” in a case of 3% or more, respectively.

TABLE 1

| | PAA | | | | | | | | |
|---|---|---|---|---|---|---|---|---|---|
| | swollen | | | | | | Cycle | | |
| | particle | | Initial | | Capacity | | swelling | | |
| | diameter | Composite | DCIR | | retention | | ratio | | Total |
| | (μm) | process | (Ω) | Evaluation | (%) | Evaluation | (%) | Evaluation | evaluation |
| Embodiment 1 | 1.0 | Dry | 1.55 | Fair | 91 | Fair | 2.6 | Fair | Fair |
| Embodiment 2 | 1.0 | Wet | 1.69 | Fair | 91 | Fair | 2.3 | Good | Good |
| Embodiment 3 | 1.4 | Dry | 1.52 | Fair | 92 | Fair | 2.5 | Fair | Fair |
| Embodiment 4 | 1.4 | Wet | 1.64 | Fair | 92 | Fair | 2.2 | Good | Good |
| Comparative | — | — | 1.50 | Fair | 92 | Fair | 3.2 | Poor | Poor |
| Embodiment | | | | | | | | | |

### Initial DCIR Value

The initial DCIR value of the battery cell using the negative electrode body of Comparative Example was 1.50Ω, and was determined to be “Fair”. On the other hand, each of the initial DCIR values of the battery cells using the negative electrode bodies 10 of Embodiments 1 to 4 was 1.55 Ω, 1.69 Ω, 1.52Ω, and 1.64Ω, and slightly increased as compared with Comparative Example, but all were determined to be “Fair” and were within the allowable range.

### Capacity Retention

The capacity retentions of the battery cells using the negative electrode bodies 10 of Embodiments 1 to 4 and the negative electrode body of Comparative Example were all substantially the same results of 91% to 92%, and the determination was “Fair”.

### Cycle Swelling Ratio

The cycle swelling ratio of the battery cell using the negative electrode body of Comparative Example was 3.2%, and was determined to be “Poor”. On the other hand, the cycle swelling ratios of the battery cells using the negative electrode bodies 10 of Embodiments 1 to 4 were 2.2% to 2.6%, and all were determined to be “Fair” or higher, exhibiting favorable performance. That is, it is considered that, in the negative electrode material layer 14, since a void could be provided around the second active material particles 18, the expansion of the electrode (that is, the negative electrode body 10 as the battery electrode) caused by the expansion of the second active material particles 18 could be suppressed. In particular, the cycle swelling ratios of the battery cells using the negative electrode bodies 10 of Embodiments 2 and 4 produced by the wet process were 2.3% and 2.2%, respectively, and the determination was “Good”. From the results, promotion of the production of composite particles 30 by the wet process, together with successful production of the composite particles 30 as intended, is considered to have acted relatively favorably to suppress the swelling of the electrode.

What is claimed is:

1. A negative electrode body comprising:
a current collector; and
a negative electrode material layer provided on the current collector, wherein the negative electrode material layer includes:
first active material particles containing a carbon material;
second active material particles containing a silicon-based material, the second active material particles being dispersed among the first active material particles; and
a superabsorbent polymer adhering to a surface of the second active material particles such that a void is provided between the superabsorbent polymer and the first active material particles.

2. The negative electrode body according to claim 1, wherein the superabsorbent polymer includes at least one selected from the group consisting of polyacrylic acid, polyvinyl alcohol, polyethylene glycol, and polyacrylonitrile.

3. The negative electrode body according to claim 1, wherein the silicon-based material includes at least one selected from the group consisting of silicon, silicon carbide, silicon monoxide, and a silicon alloy.

4. The negative electrode body according to claim 1, wherein, in the negative electrode material layer, a content of the superabsorbent polymer in a unit region including the second active material particles is at least 10 times a content of the superabsorbent polymer in a unit region not including the second active material particles.

5. A manufacturing method of a negative electrode body, the manufacturing method comprising:
producing composite particles by causing a superabsorbent polymer to adhere to a surface of second active material particles containing a silicon-based material;
producing a negative electrode material paste by mixing the composite particles, first active material particles containing a carbon material, and water;
applying the negative electrode material paste onto a surface of a current collector; and
drying the negative electrode material paste applied onto the surface of the current collector to shrink the superabsorbent polymer adhering to the surface of the second active material particles, and providing a void between the superabsorbent polymer and the first active material particles.

6. The manufacturing method according to claim 5, wherein, in the producing the composite particles, the composite particles are produced by mixing the second active material particles, the superabsorbent polymer, and water.
